(19) United States
(12) Patent Application Publication
(10) Pub. No.: US 2005/0217645 A1
(43) Pub. Date: Oct. 6, 2005

(54) Evaporated fuel collecting apparatus

(75) Inventors: Kanehiro Fukaya, Obu-shi (JP); Hirokazu Konohara, Obu-shi (JP); Takashi Nagai, Obu-shi (JP)

Correspondence Address: OLIFF & BERRIDGE, PLC, P.O. BOX 19928, ALEXANDRIA, VA, 22320, US

(73) Assignee: Aisan Kogyo Kabushiki Kaisha, Obu-shi (JP)

(21) Appl. No.: 11/078,298

(22) Filed: Mar. 14, 2005

(30) Foreign Application Priority Data
Mar. 31, 2004 (JP) 2004-106694

(51) Int. Cl. F02M 33/02

(52) U.S. Cl. 123/519

(57) ABSTRACT

An evaporated fuel collecting apparatus comprises a canister containing an adsorbent for collecting evaporated fuel (vapor) generated in a fuel tank, an inflow port, a purge port, and an atmospheric port, which are formed in the canister. The inflow port is used to introduce the vapor generated in the furl tank into the canister. The purge port is used to purge the vapor collected in the canister. The atmospheric port is used to introduce atmospheric air into the canister. The canister is provided with a photocatalyst device including a photocatalyst for oxidatively decompose the vapor when exposed to light irradiation and an ultraviolet LED which irradiates light to the photocatalyst. The photocatalyst device is disposed in correspondence with the atmospheric port.

### BACKGROUND OF THE INVENTION

1. Field of the Invention

The present invention relates to an evaporated fuel collecting apparatus for collecting evaporated fuel generated in a fuel tank into a canister.

2. Description of Related Art

An evaporated fuel collecting apparatus including a canister for collecting evaporated fuel (vapor) generated in a fuel tank has heretofore been known as one of apparatuses mounted in a vehicle. This apparatus is arranged to collect the vapor generated in the fuel tank by adsorption onto an adsorbent provided in the canister during stop of the vehicle or during refueling. Such apparatus purges fuel components (hydrocarbons (HC) and others) of the collected vapor into an intake passage by use of negative pressure generated in the intake passage during operation of an engine, thereby making the vapor available for combustion in the engine. Japanese unexamined patent publication No. H7(1995)-180624 (pages 2-3 and FIG. 1) and Japanese unexamined patent publication No. H4(1992)-66764 (pages 1-4 and FIGS. 1 and 2) disclose examples of the evaporated fuel collecting apparatus mentioned above.

A fuel-gas diffusion preventing apparatus disclosed in the publication '624 was proposed in order to prevent the vapor collected in a canister from diffusing into the atmosphere. A commonly used canister includes an inflow port for introducing the vapor generated in a fuel tank into the canister, a purge port for purging the collected vapor from the canister into an intake passage, and an atmospheric port for introducing atmospheric air into the canister. During engine operation, the vapor is released from the adsorbent by the air introduced into the canister through the atmospheric port, and the released vapor is purged into the intake passage through the purge port.

Some atmospheric ports are constantly open. Such constantly open atmospheric port may cause diffusion of vapor from a canister into the atmosphere during engine stop. Hence, the canister has been relatively increased in volume to enhance its vapor adsorption capacity for prevention of vapor diffusion into the atmosphere. Increasing the canister volume, however, would go against a demand for a reduction in apparatus size. Further, the constantly open atmospheric port may not surely prevent the vapor diffusion into the atmosphere even if the canister volume is increased, which may cause constant leakage of a small amount of vapor through the atmospheric port. To avoid such problems, the apparatus disclosed in the publication '624 is provided with a control valve in the atmospheric port of the canister to thereby close the atmospheric port during engine stop, blocking the vapor flow from the canister into the atmosphere.

On the other hand, an evaporated fuel collecting apparatus the publication '764 was proposed in order to completely release high boiling hydrocarbon of the vapor adsorbed on the adsorbent in the canister. In this apparatus, the canister is shaped in cylinder form which contains an adsorbent (activated carbon). The apparatus is provided with an inflow port and a purge port on top of the canister and an atmospheric port on the other side of the canister interposing the adsorbent. In an upper part of the canister in correspondence with the inflow port and the purge port, a photocatalyst is provided coexistent with a part of the adsorbent (activated carbon) and a light irradiator for irradiating light to the photocatalyst is also disposed. The apparatus disclosed in the publication '764 is arranged to oxidatively decompose high boiling hydrocarbon by the photocatalyst exposed to light irradiation into low boiling hydrocarbon low in the number of molecules or carbon dioxide, and water, thus facilitating release of vapor from the adsorbent.

Since the apparatus disclosed in the publication '624 is provided with the control valve for blocking the vapor flow from the canister into the atmosphere, there are problems that a structure associated with the atmospheric port becomes complicated, and the canister needs much space for the control valve and thus the demand for a reduction in apparatus size could not be satisfied.

In the apparatus disclosed in the publication '764, the atmospheric port is constantly open, which may cause leakage of vapor through the atmospheric port. Furthermore, this publication does not disclose nor suggest any measure against the vapor leakage through the atmospheric port.

### SUMMARY OF THE INVENTION

The present invention has been made in view of the above circumstances and has an object to overcome the above problems and to provide an evaporated fuel collecting apparatus capable of preventing vapor collected in a canister from diffusing into the atmosphere through an atmospheric port.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided an evaporated fuel collecting apparatus comprising: a canister for collecting evaporated fuel generated in a fuel tank; an adsorbent contained in the canister for adsorbing thereon the evaporated fuel; the canister including an inflow port through which the evaporated fuel generated in the fuel tank is introduced into the canister, a purge port through which the collected evaporated fuel is purged from the canister, and an atmospheric port through which atmospheric air is introduced into the canister; a photocatalyst which is provided in the canister in correspondence with the atmospheric port and oxidatively decomposes the evaporated fuel when exposed to light irradiation; and light irradiation means for irradiating light to the photocatalyst.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a schematic structural view of an engine system in a first embodiment;

FIG. 2 is a front sectional view of a canister;

FIG. 3 is a plan view of a photocatalyst carrying porous plate, showing an irradiation distribution of light onto the plate;

FIG. 4 is a flowchart showing a control program of a photocatalyst device;

FIG. 5 is a graph showing a photocatalytic reaction test result;

FIG. 6 is a graph showing a photocatalytic reaction test result;

FIG. 7 is a schematic view showing a photocatalytic reaction test;

FIG. 8 is a flowchart showing a control program of the photocatalyst device in a second embodiment;

FIG. 9 is a front sectional view of a canister in a third embodiment;

FIG. 10 is a front view of a porous plate, showing arrangement of optical fibers therein;

FIG. 11 is a schematic structural view of an engine system in a fourth embodiment;

FIG. 12 is a sectional view of an air filter;

FIG. 13 is a schematic structural view of an engine system in a fifth embodiment; and

FIG. 14 is a sectional view of a high-density air filter.

### DETAILED DESCRIPTION OF THE PREFERRED EMBODIMENTS

### First Embodiment

A detailed description of a first preferred embodiment of an evaporated fuel collecting apparatus embodying the present invention will now be given referring to the accompanying drawings.

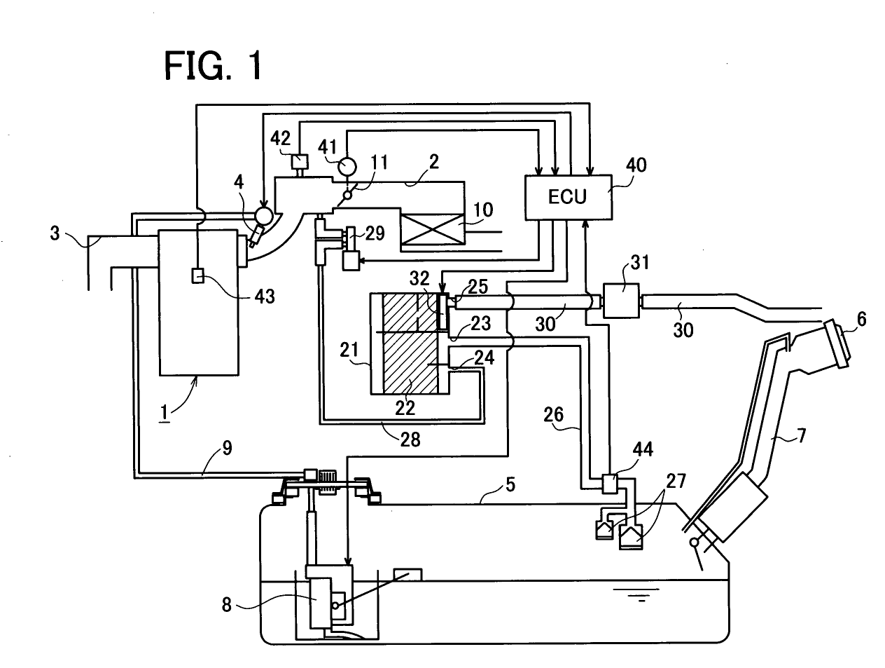

FIG. 1 is a schematic structural view of an engine system mounted in a motor vehicle. An engine 1 constructing the engine system is provided with an intake passage 2 for taking in outside air and an exhaust passage 3 for discharging exhaust gas. The engine 1 is further provided with an injector 4 for each of a plurality of combustion chambers (not shown). The engine system further includes a fuel tank 5 which stores fuel. A fuel filling pipe 7 including a fuel filling pipe cap 6 is connected with the fuel tank 5. After the cap 6 is opened, fuel is poured into the fuel tank 5 through the fuel filling pipe 7 for refueling the tank 5. The fuel tank 5 includes a built-in fuel pump 8. The fuel discharged from the tank 5 by the fuel pump 8 is supplied to each injector 4 through a fuel line 9. By operation of each injector 4, the fuel supplied thereto is injected to the intake passage 2. In this intake passage 2, air is introduced after being cleaned up by an air cleaner 10. A mixture of the introduced air and the injected fuel is introduced into each combustion chamber. In each combustion chamber, an ignition device (not shown) generates sparks to explode and combust the introduced air-fuel mixture. After combustion, exhaust gas is discharged to the outside through the exhaust passage 3.

Disposed in the intake passage 2 is a throttle valve 11 which is opened and closed for regulating an amount of intake air. A throttle sensor 41 is connected to the throttle valve 11 to detect an opening degree (throttle angle) TA thereof. An intake pressure sensor 42 is provided to detect intake pressure in the intake passage 2. A rotational speed sensor 43 is set in the engine 1 to detect rotational speed (engine rotational speed) NE thereof. These throttle sensor 41, intake pressure sensor 42, and rotational speed sensor 43 correspond to operating state detection means for detecting an operating state of the engine 1.

In the motor vehicle, an evaporated fuel processing apparatus including the evaporated fuel collecting apparatus is mounted. This apparatus is used to collect and process evaporated fuel (vapor) generated in the fuel tank 5 without diffusion (release) into the atmosphere. The apparatus includes a canister 21 for collecting the vapor generated in the fuel tank 5 and an adsorbent 22 made of activated carbon, which is contained in the canister 21 to adsorb the vapor.

The canister 21 includes an inflow port 23 through which the vapor generated in the fuel tank 5 is introduced into the canister 21, a purge port 24 through which the collected vapor is purged from the canister 21, and an atmospheric port 25 through which atmospheric air is introduced into the canister 21. A vapor line 26 extending from the fuel tank 5 communicates with the inflow port 23. At an inlet of the vapor line 26, a float valve 27 is provided. At some midpoint of the vapor line 26, a vapor concentration sensor 44 is disposed to detect the concentration of vapor (vapor concentration) Cbp generated in the fuel tank 5. This sensor 44 corresponds to concentration detection means of the invention. A purge line 28 extending from the purge port 24 communicates with the intake passage 2 located downstream from the throttle valve 11. A purge control valve 29 is disposed at some midpoint of the purge line 28. An atmospheric line 30 extending from the atmospheric port 25 has an end opening into the atmosphere. An air filter 31 is disposed at some midpoint of the atmospheric line 30.

The canister 21 collects the vapor introduced therein through the vapor line 26 and the inflow port 23, by adsorbing the vapor onto the adsorbent 22, and discharges only the gas that does not contain fuel components (hydrocarbon (HC) and others) of the vapor into the atmosphere through the atmospheric port 25, the atmospheric line 30, and the air filter 31. During operation of the engine 1, intake negative pressure generated in the intake passage 2 acts on the purge line 28. At this time, the purge valve 29 is opened, allowing the vapor collected in the canister 21 to be purged into the intake passage 2 through the purge line 28. The purge control valve 29 is constructed of an electromagnetic valve, of which opening degree is duty-controlled for controlling an amount of purge flow.

In the canister 21, a photocatalyst device 32 is provided in correspondence with the atmospheric port 25. This photocatalyst device 32 is arranged to oxidize and decompose the vapor, which is going to leak through the atmospheric port 25 into the atmosphere, into carbon dioxide and water. In the present embodiment, the canister 21 including the adsorbent 22, inflow port 23, purge port 24, atmospheric port 25, photocatalyst device 32, and others constitutes the evaporated fuel collecting apparatus.

In the present embodiment, an electronic control unit (ECU) 40 is provided to control the evaporated fuel collecting apparatus and the evaporated fuel processing apparatus. To the ECU 40, various sensors 41 to 44 mentioned above are connected and furthermore the injector 4, fuel pump 8, purge control valve 29, and photocatalyst device 32 are connected individually. In the present embodiment, the ECU 40 controls the purge control valve 29 based on detection signals of the sensors 41 to 44 in order to control the purge flow amount of vapor from the canister 21 according to the operating state of the engine 1. Further, the ECU 40 controls the photocatalyst device 32 based on a detection signal from the vapor concentration sensor 44 in order to prevent the vapor collected in the canister 21 from diffusing into the atmosphere through the atmospheric port 25.

The ECU 40 includes, as well known, a central processing unit (CPU), a read only memory (ROM), a random access memory (RAM), a backup RAM, an external input circuit and an external output circuit, and others. The ROM stores in advance various programs and predetermined data. The RAM temporarily stores computing results of a CPU. The backup RAM saves the previously stored data. The CPU executes various controls based on the detection signals transmitted from the sensors 41 to 44 to the CPU through an input circuit.

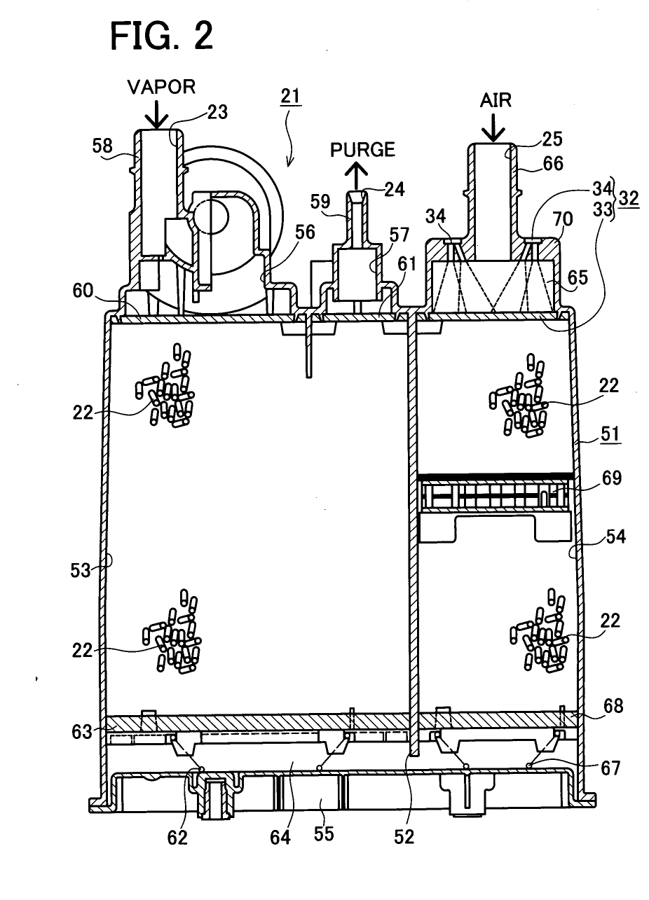

The structure of the canister 21 is explained below in detail. FIG. 2 is a front sectional view of the canister 21. A casing 51 forming the canister 21 is internally divided into a large chamber 53 and a small chamber 54 by a partition wall 52. The casing 51 is closed at its lower end by a bottom cover 55. Above the large chamber 53, there are an inflow chamber 56 for introducing vapor and a purge chamber 57 for purging vapor. A vapor line pipe joint 58 including the inflow port 23 is formed communicating with the inflow chamber 56. A purge line pipe joint 59 including the purge port 24 is formed communicating with the purge chamber 57. The vapor line 26 is connected to the vapor line joint 58. The purge line 28 is connected to the purge line joint 59. In the upper part of the large chamber 53, porous plates 60 and 61 are disposed corresponding to the inflow chamber 56 and the purge chamber 57 respectively. In the lower part of the large chamber 53, a porous plate 63 is supported by a spring 62 and the like on the bottom cover 55. An air layer 64 is provided between the porous plate 63 and the bottom cover 55. The large chamber 53 contains the adsorbent 22 sandwiched between the upper porous plates 60 and 61 and the lower porous plate 63.

Formed above the small chamber 54 is an atmospheric chamber 65 for introducing atmospheric air. An atmospheric line pipe joint 66 including the atmospheric port 25 is formed communicating with the atmospheric chamber 65. The atmospheric line 30 is connected to the atmospheric line joint 66. In the upper part of the small chamber 54, a photocatalyst carrying porous plate 33 that carries a photocatalyst on a surface is disposed in correspondence with the atmospheric chamber 65. As the photocatalyst in the present embodiment, materials including titanium dioxide (TiO₂) as a main component are used. This porous plate 33 has a three-dimensional skeleton structure, including pores that cross one another in every direction. The porous plate 33 is coated with the photocatalyst so that each pore is not filled or stopped up with the photocatalyst, thus remaining open, but each pore wall is coated with it. The vapor being going to flow from the adsorbent 22 toward the atmospheric port 25 can come into contact with the surface of the porous plate 33. In the lower part of the small chamber 54, a porous plate 68 is supported by a spring 67 and the like on the bottom cap 55. The air layer 64 is provided between the porous plate 68 and the bottom cover 55. The small chamber 54 contains the adsorbent 22 sandwiched between the upper photocatalyst carrying porous plate 33 and the lower porous plate 68. The adsorbent 22 contained in the small chamber 54 is divided into an upper part and lower part by a porous plate block 69 disposed at about the midpoint of the small chamber 54.

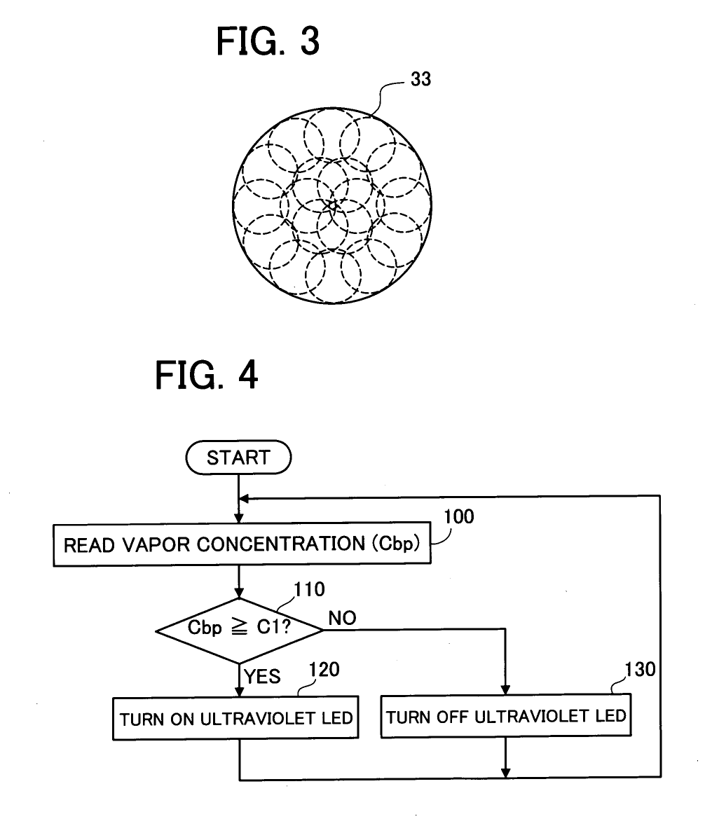

As shown in FIG. 2, the atmospheric chamber 65 is formed of a cylindrical part 70 integrally formed with the casing 51. The atmospheric line joint 66 is provided protruding from an upper center of the cylindrical part 70. On the cylindrical part 70, a plurality of ultraviolet LEDs 34 corresponding to light irradiation means of the invention are provided. These ultraviolet LEDs 34 are arranged at equally angular intervals circumferentially about the atmospheric line joint 66. Each LED 34 is located to irradiate light to the photocatalyst carrying porous plate 33 in the atmospheric chamber 65. Each LED 34 is electrically connected to the ECU 40 and is turned on upon receipt of a control signal from the ECU 40. FIG. 3 shows an irradiation distribution of the light from each LED 34 onto the surface of the plate 33 by dashed circular lines. The light from each LED 34 is irradiated in spot form to the surface of the plate 33. A plurality of spot light beams are applied at equally angular intervals on a double circle to irradiate the whole area of the upper surface of the photocatalyst carrying porous plate 33. In the present embodiment, the photocatalyst device 32 is constructed of the photocatalyst carrying porous plate 33 and the plurality of ultraviolet LEDs 34.

The details of control of the photocatalyst device 32 to be executed by the ECU 40 are explained below. FIG. 4 is a flowchart of a control program thereof.

In step (S) 100, during operation or stop of the engine 1, the ECU 40 reads out a vapor concentration Cap detected by the vapor concentration sensor 44.

In S110, the ECU 40 determines whether the read vapor concentration Cbp is a predetermined reference value C1 or more. If Cbp is C1 or more, the ECU 40 turns on each ultraviolet LED 34 in S120. Thus, the upper surface of the photocatalyst carrying porous plate 33 is irradiated with the light from each LED 34. If Cbp is lower than C1, on the other hand, the ECU 40 turns off each ultraviolet LED 34 in S130.

According to the evaporated fuel collecting apparatus in the present embodiment explained above, when the vapor adsorbed on the adsorbent 22 and collected in the canister 21 is going to leak through the atmospheric port 25, each ultraviolet LED 34 is turned on to irradiate light to the upper surface of the photocatalyst carrying porous plate 33. Accordingly, the irradiated photocatalyst oxidatively decomposes the fuel components such as hydrocarbon (HC) of the vapor, into carbon dioxide and water. This can prevent the vapor collected in the canister from directly diffusing into the atmosphere through the atmospheric port 25. Hence, the need to increase the vapor adsorption capacity of the canister 21 can be eliminated and also the canister 21 can be reduced in size. This makes it possible to improve mountability of the canister 21 in motor vehicles.

For preventing the vapor diffusion into the atmosphere, in the present embodiment, the photocatalyst carrying porous plate 33 and the ultraviolet LEDs 34 are simply provided in correspondence with the atmospheric chamber 65 of the canister 21. The structure associated with the atmospheric port 25 can be simple as compared with a structure including a control valve in an atmospheric port, and the photocatalyst device 32 does not need much space, which can meet a demand for a reduction in size of the vapor fuel collecting apparatus.

In the present embodiment, the ECU 40 turns on each ultraviolet LED 34 only when the vapor concentration Cap detected by the vapor concentration sensor 44 is the predetermined reference value C1 or more, thereby irradiating light to the photocatalyst carrying porous plate 33. Accordingly, each ultraviolet LED 34 can be operated only when needed to prevent vapor leakage into the atmosphere. It is therefore possible to save energy needed for preventing the vapor diffusion into the atmosphere.

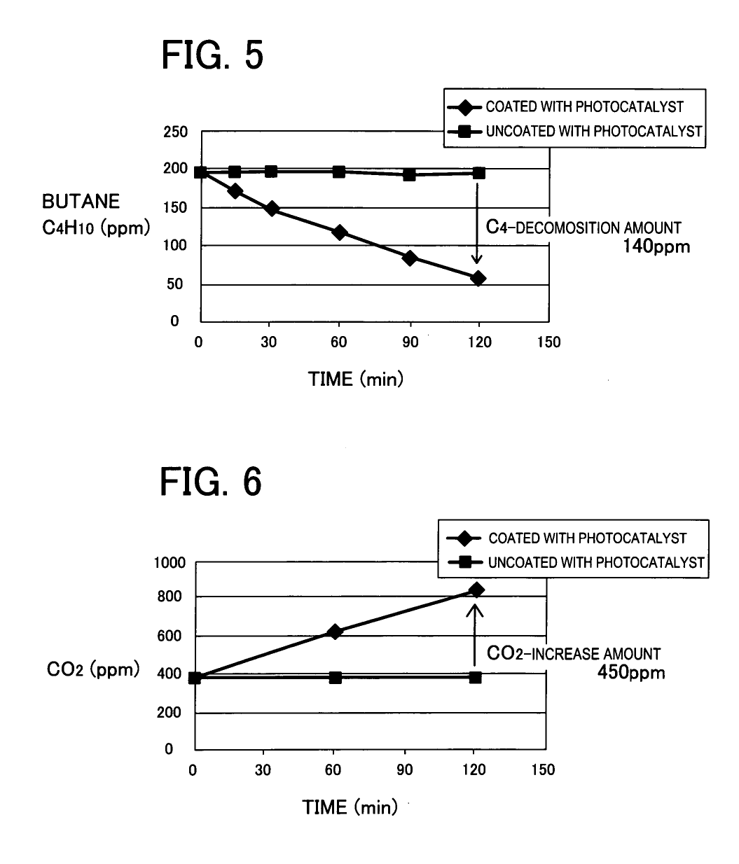

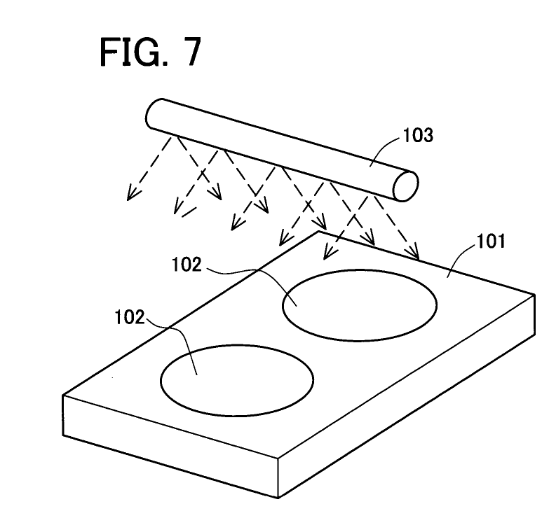

FIGS. 5 and 6 are graphs showing results of a photocatalyst reactive test assuming oxidative decomposition of vapor by a photocatalyst. FIG. 7 is a schematic view showing the photocatalyst reactive test. This test was performed by putting schales 102 of a 90-mm diameter in an evaluation bag 101 of a 3-liter capacity. In each schale 102, a large quantity of glass beads each having a 2-mm diameter and being coated with a photocatalyst were spread in one layer. This evaluation bag 101 was placed in an atmosphere of butane (C₄H₁₀) with a 200 ppm concentration at normal temperature (room temperature) and normal pressure (atmospheric pressure) and was irradiated with light of an ultraviolet intensity of 4 mW/cm² (corresponding to sunlight in the middle of summer) of a predetermined light source 103. A similar test was also performed by using glass beads uncoated with a photocatalyst.

FIG. 5 shows variations in butane concentration with time after light irradiation. FIG. 6 shows variations in carbon dioxide concentration with time after light irradiation. As shown in FIG. 5, the test using the glass beads coated with a photocatalyst gave the result that the butane concentration decreased by 140 ppm from 200 ppm to 60 ppm for a lapse of 120 minutes from a start of light irradiation, whereas the test using the glass beads uncoated with a photocatalyst gave the result that the butane concentration remained substantially unchanged from 200 ppm. As shown in FIG. 6, on the other hand, the test using the glass beads coated with a photocatalyst gave the result that the carbon dioxide (CO₂) concentration increased by 450 ppm from 400 ppm to 850 ppm for a lapse of 120 minutes from the start of light irradiation, whereas the test using the glass beads uncoated with a photocatalyst gave the result that the carbon dioxide concentration remained substantially unchanged from 400 ppm. It is clear from the above test results that light irradiation to a photocatalyst could cause oxidative decomposition of butane into carbon dioxide and water. Accordingly, the effect of oxidative decomposition by the photocatalyst is expected to be effective to the vapor including hydrocarbon (HC).

### Second Embodiment

A second embodiment embodying an evaporated fuel collecting apparatus of the invention will be explained below, referring to the accompanying drawings.

In each of the embodiments which will be explained below, identical elements or components to those in the first embodiment are indicated by the same numerals and their explanations are omitted herein. The following description is made with a focus on different features from those in the first embodiment.

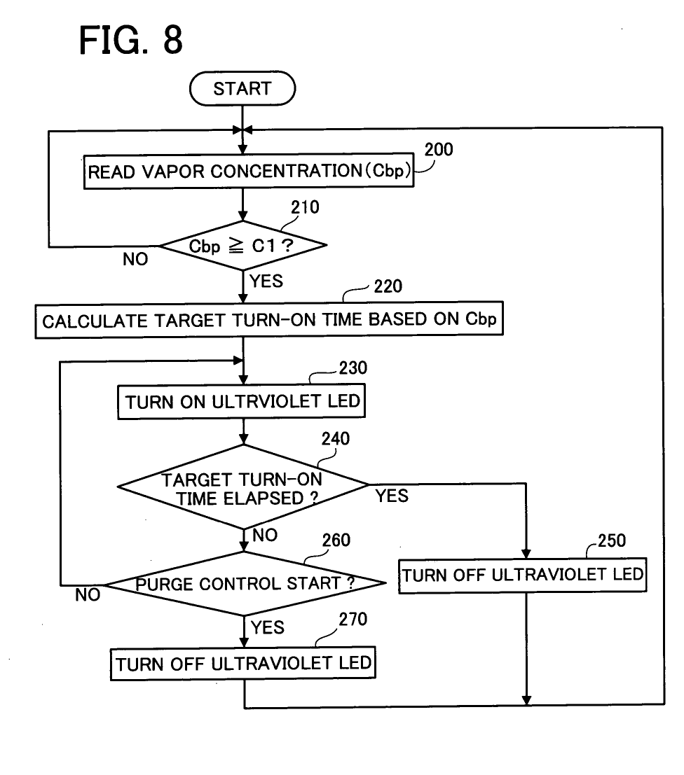

In the present embodiment, the control details of a photocatalyst device 32 to be executed by an ECU 40 are different from those in the first embodiment. FIG. 8 shows a flowchart of a control program.

In S200, the ECU 40 reads a vapor concentration Cap detected by a vapor concentration sensor 44 during operation or stop of an engine 1.

In S210, the ECU 40 determines whether the read vapor concentration Cap is a predetermined reference value C1 or more. The ECU 40 returns the control flow to S200 if Cbp is lower than C1, whereas the ECU 40 advances the control flow to S220 if Cap is C1 or more.

In S220, the ECU 40 calculates a target turn-on time (duration) to oxidatively decompose the an amount of vapor which can be estimated according to the read vapor concentration Cbp. This target turn-on time is determined based on previously experimentally determined data. In S230, the ECU 40 turns on each ultraviolet LED 34.

In S240, the ECU 40 determines whether or not the target turn-on time has elapsed from the start of turn-on. If the target turn-on time has elapsed, the ECU 40 turns off each ultraviolet LED 34 in S250. If the target turn-on time has not elapsed yet, the ECU 40 advances the program to S260.

In S260, the ECU 40 determines whether or not a purge control that is separately executed has been started. If the purge control has not been started, the ECU 40 returns the program to S230 to keep each ultraviolet LED 34 lit up. If the purge control has been started, the ECU 40 turns off each ultraviolet LED 34.

According to the present embodiment, each ultraviolet LED 34 is turned on only for the target turn-on time according to the vapor concentration Cap. This makes it possible to turn on each ultraviolet LED 34 for a just enough time, so that the vapor can be appropriately oxidized and decomposed by the action of a photocatalyst and energy needed for preventing diffusion of the vapor into the atmosphere can be saved. The other functions and effects in the present embodiment are basically the same as those in the first embodiment.

### Third Embodiment

A third embodiment of an evaporated fuel collecting apparatus of the invention will be explained in detain below with reference to the accompanying drawings.

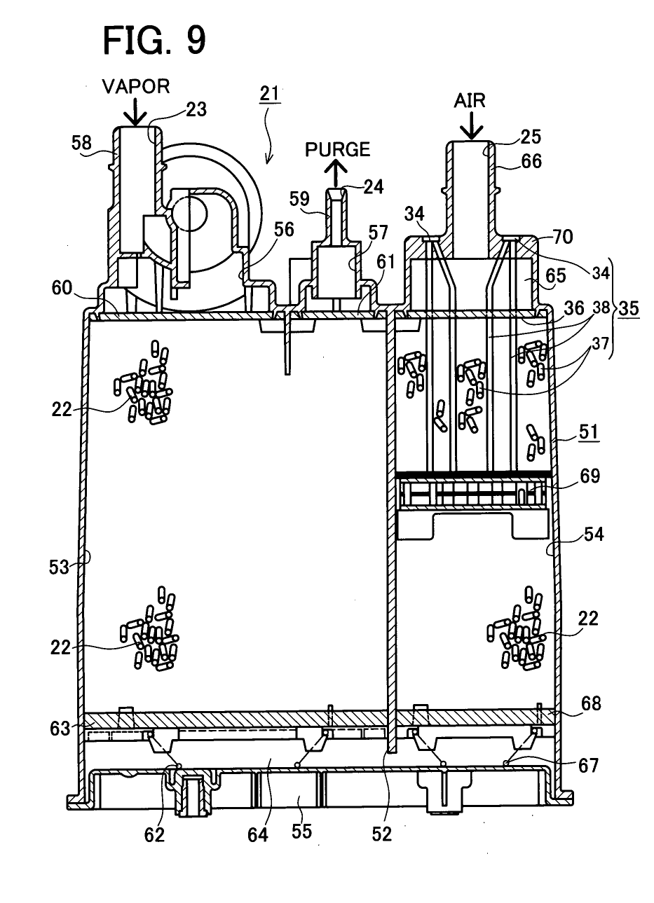

In the present embodiment, a photocatalyst device 35 in a canister 21 is different in structure from that in the first embodiment. FIG. 9 is a sectional view of the canister 21.

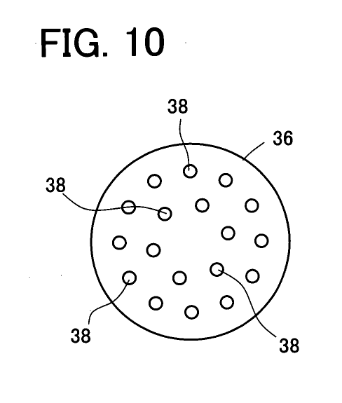

In the present embodiment, instead of the photocatalyst carrying porous plate 33, a porous plate 36 which does not carry a photocatalyst is provided in correspondence with an atmospheric chamber 65. In the present embodiment, a photocatalyst carrying adsorbent 37 which carries a photocatalyst is contained in a space between the porous plate 36 and a porous plate block 69. A plurality of exposure-type optical fibers 38 extending from each ultraviolet LED 34 are placed passing through the porous plate 36 into the adsorbent 37. FIG. 10 is a plan view of the porous plate 36, showing arrangement of the plurality of optical fibers 38 therein. The optical fibers 38 are disposed at equally angular intervals on a double circle in plan view. The photocatalyst carrying adsorbent 37 is made of activated carbon having particles each surface of which is coated with a photocatalyst. The surface of each optical fiber 38 is thinly coated with a photocatalyst in order to decompose stains such as activated carbon. The light of each ultraviolet LED 34 is allowed to leak from each optical fiber 38 to the surroundings, thereby irradiating the photocatalyst carrying adsorbent 37. The vapor passing through this adsorbent 37 will be oxidatively decomposed by the photocatalyst exposed to the light. Accordingly, the present embodiment can provide the same functions and effects as those in the above mentioned embodiments.

### Fourth Embodiment

A fourth embodiment of an evaporated fuel collecting apparatus of the invention will be explained below in detail with reference to the accompanying drawings.

A different structure of the present embodiment from the above first through third embodiments is in that, instead of disposing the photocatalyst devices 32 and 35 in the canister 21, a photocatalyst device is provided in an air filter 31 of an atmospheric line 30.

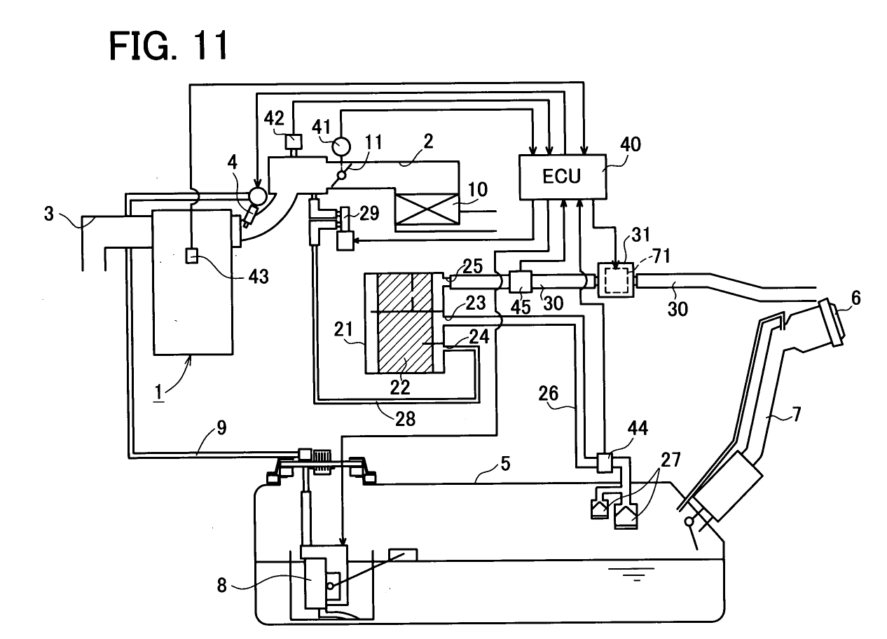

FIG. 11 is a schematic structural view of an engine system in the present embodiment. As shown in FIG. 11, in the present embodiment, a photocatalyst device 71 is set in the air filter 31. In the atmospheric line 30 located upstream of the air filter 31, a vapor concentration sensor 45 is provided in addition to a vapor concentration sensor 44. The photocatalyst device 71 and the vapor concentration sensor 45 are connected to an ECU 40. The control details of the photocatalyst device 71 to be executed by the ECU 40 are substantially the same as those shown by the flowcharts in FIGS. 4 and 8.

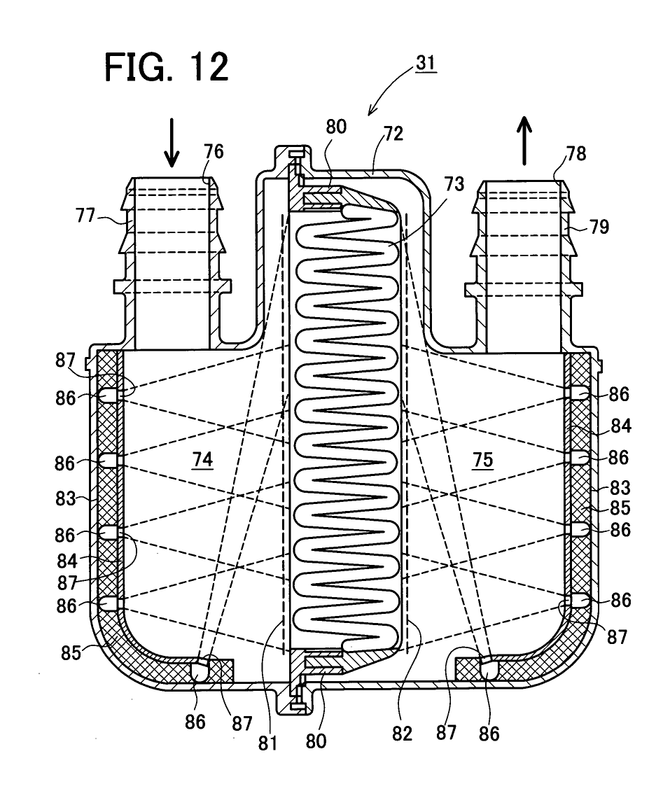

FIG. 12 is a sectional view of the air filter 31. A casing 72 constituting the air filter 31 is internally divided by a filter body 73 into a first air chamber 74 and a second air chamber 75. The casing 72 is integrally provided with a first pipe joint 77 including a first port 76, which communicates with the first air chamber 74, and a second pipe joint 79 including a second port 78, which communicates with the second air chamber 75. The filter body 73 is shaped in accordion form in section and fixed to an inner wall of the casing 72 through brackets 80. On right and left sides of the filter body 73, first and second photocatalyst carrying sheets 81 and 82 are placed covering over the sides respectively. These sheets 81 and 82 are breathable and carry thereon photocatalysts. In this structure, air having entered in the first air chamber 74 through the first port 76 is allowed to pass through the first photocatalyst carrying sheet 81, the filter body 73, and the second photocatalyst carrying sheet 82, into the second air chamber 75, and then the air is discharged through the second port 78. The air having entered in the air filter 31 is filtered while passing through the filter body 73.

An LED module 83 is provided substantially all over the inner wall of the casing 72. This LED module 83, which is shaped like a plate, is bonded onto an inner wall of the casing 72 and held by a plate-like holder 84. The LED module 83 includes a base plate 85 in which a plurality of ultraviolet LEDs 86 are embedded at scattered places. In the holder 84, lenses 87 are disposed in one-to-one correspondence with the ultraviolet LEDs 86. A surface of each lens 87 is thinly coated with a photocatalyst in order to decompose stains such as organic matters. Each ultraviolet LED 86 corresponds to light irradiation means of the invention. As shown by broken lines in FIG. 12, light emitted from each ultraviolet LED 86 is collected to be irradiated in a predetermined direction by each associated lens 87. The light beams emitted from the ultraviolet LEDs 86 of the LED module 83 provided in the first air chamber 74 are irradiated together to almost all the surface of the first photocatalyst carrying sheet 81. Similarly, the light beams emitted from the ultraviolet LEDs 86 of the LED module 83 provided in the second air chamber 75 are irradiated together to almost all the surface of the second photocatalyst carrying sheet 82. In the present embodiment, the LED module 83 and each of the photocatalyst carrying sheets 81 and 82 constitute the photocatalyst device 71.

According to the evaporated fuel collecting apparatus in the present embodiment described above, when the vapor collected in the canister 21 by adsorption onto the adsorbent 22 is going to pass through the atmospheric port 25, the atmospheric line 30, and the air filter 31 to leak into the atmosphere, each ultraviolet LED 86 of the LED module 83 built in the air filter 31 is turned on to irradiate light to each photocatalyst carrying sheet 81, 82. Thus, the hydrocarbon of the vapor passing through each sheet 81, 82 is oxidatively decomposed by the photocatalyst exposed to light irradiation into carbon dioxide and water. This can prevent the vapor having leaked through the atmospheric port 25 of the canister 21 into the atmospheric line 30 from diffusing into the atmosphere. Consequently, the need to increase the vapor adsorption capacity of the canister is eliminated and therefore the canister 21 can be reduced in size. This makes it possible to improve mountability of the canister 21 in motor vehicles. The other functions and effects are substantially the same as those in the above mentioned embodiments.

### Fifth Embodiment

A fifth embodiment of an evaporated fuel collecting apparatus of the invention will be explained below in detail with reference to the accompanying drawings.

The present embodiment differs from the fourth embodiment in that, instead of providing the photocatalyst device 71 in the air filter 31, a photocatalyst device is provided in a high-density air filter 90 additionally disposed in the atmospheric line 30 located downstream of the air filter 31.

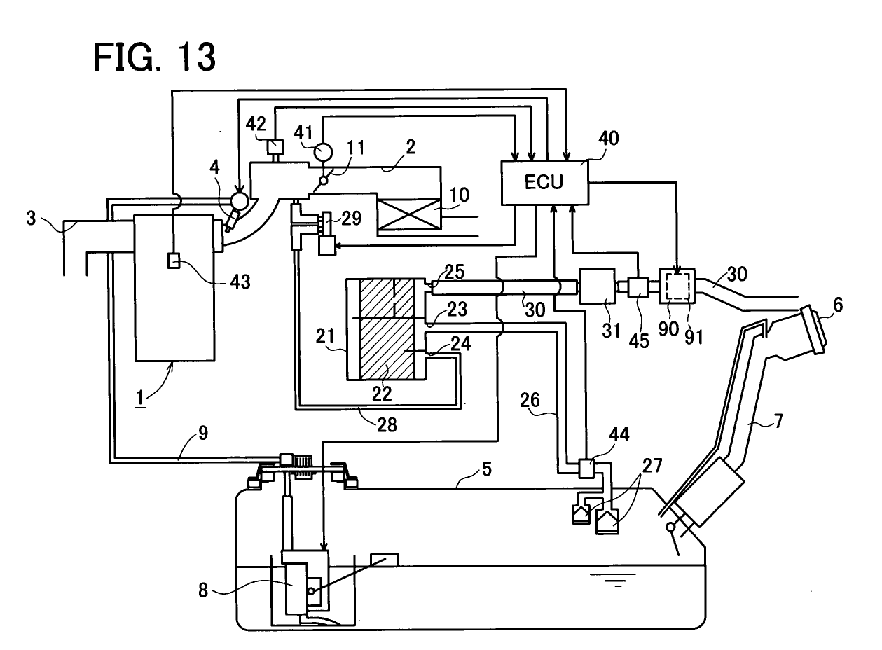

FIG. 13 is a schematic structural view of an engine system in the present embodiment. As shown in FIG. 13, in the present embodiment, a photocatalyst device 91 is provided in the high-density air filter 90. In the present embodiment, a vapor concentration sensor 45 is disposed in the atmospheric line 30 located upstream of the high-density air filter 90. The photocatalyst device 91 and the vapor concentration sensor 45 are connected to the ECU 40. The control details of the photocatalyst device 91 to be executed by the ECU 40 executes are substantially the same as those shown by the flowcharts in FIGS. 4 and 8.

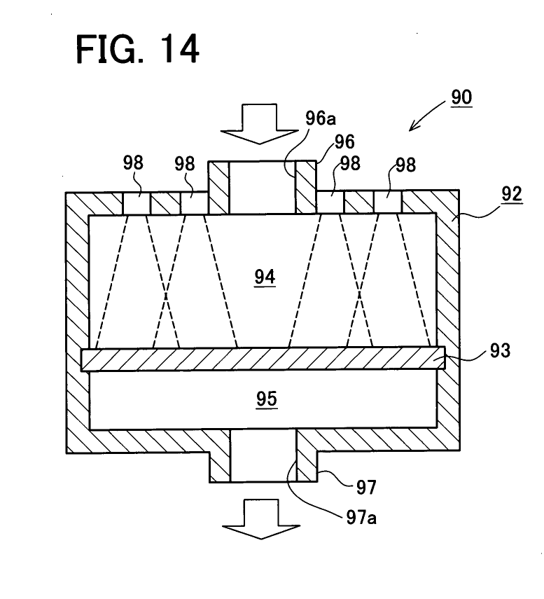

FIG. 14 is a sectional view of the high-density air filter 90. A casing 92 constituting this air filter 90 is internally divided by a photocatalyst carrying filter 93 that carries a photocatalyst into a first air chamber 94 and a second air chamber 95. The casing 92 is integrally provided with a first pipe joint 96 including a first port 96a, which communicates with the first air chamber 94, and a second pipe joint 97 including a second port 97a, which communicates with the second air chamber 95. The photocatalyst carrying filter 93 is shaped like a plate and fixed to an inner wall of the casing 92. In this structure, air having entered in the first air chamber 94 through the first port 96a is allowed to pass through the photocatalyst carrying filter 93 into the second air chamber 95, and then the air is discharged through the second port 97a. A filter body constituting the photocatalyst carrying filter 93 is made of stainless wool, which does not allow high molecular (polymer) components more than methane to pass therethrough, while allowing low molecular components such as carbon dioxide, oxygen, and nitrogen to pass therethrough.

In an upper wall of the casing 92 of the high-density air filter 90, a plurality of ultraviolet LEDs 98 corresponding to light irradiation means of the invention are embedded. As shown by broken lines in FIG. 14, light emitted from each ultraviolet LED 98 is irradiated downward in the first air chamber 94. The light beams emitted from the ultraviolet LEDs 98 are irradiated together to almost all the surface of the photocatalyst carrying filter 93.

In the present embodiment, accordingly, when the vapor collected in the canister 21 by adsorption onto the adsorbent 22 is going to pass through the atmospheric port 25, the atmospheric line 30, and the air filter 31 to leak into the atmosphere, the ultraviolet LEDs 98 provided in the high-density air filter 90 are turned on to irradiate light to the photocatalyst carrying filter 93. Thus, the hydrocarbon of the vapor passing through the filter 93 is oxidatively decomposed by the photocatalyst exposed to light irradiation into carbon dioxide and water. This can prevent the vapor having leaked through the atmospheric port 25 of the canister 21 into the atmospheric line 30 from diffusing into the atmosphere. Consequently, the need to increase the vapor adsorption capacity of the canister is avoided and therefore the canister 21 can be reduced in size. This makes it possible to improve mountability of the canister 21 in motor vehicles. The other functions and effects are substantially the same as those in the above mentioned embodiments.

The present invention may be embodied in other specific forms without departing from the spirit or essential characteristics thereof.

Used in the above mentioned embodiments are the photocatalyst carrying porous plate 33 formed of a porous plate that carries a photocatalyst, the photocatalyst carrying adsorbent 37 formed of an adsorbent that carries a photocatalyst, the photocatalyst carrying sheets 81 and 82 each formed of a breathable sheet that carries a photocatalyst, and the photocatalyst carrying filter 93 formed of a filter body that carries a photocatalyst, respectively. Instead of using those elements, a photocatalyst carrying honeycomb formed of a ceramic honeycomb that carries a photocatalyst or photocatalyst carrying beads formed of beads that carry a photocatalyst may be used.

In the fourth embodiment, the photocatalyst carrying sheets 81 and 82 each formed of a breathable sheet carrying a photocatalyst are used. Instead thereof, a photocatalyst carrying filter formed of the filter body 72 that carries a photocatalyst on a surface may be used.

In each of the above mentioned embodiments, the ultraviolet LED 34 or the ultraviolet LEDs 86 and 98 are used as the light irradiation means for irradiating light to the photocatalyst. Alternatively, sunlight may be introduced into an optical fiber to irradiate the photocatalyst. With this structure, there is no need to electrically operate the ultraviolet LEDs or others, which can further reduce energy needed for preventing vapor diffusion into the atmosphere.

In each of the above mentioned embodiments, the photocatalyst includes titanium dioxide (TiO₂) as a main ingredient. Alternatively, the photocatalyst may include, as the main ingredient, cadmium selenide (CdSe), cadmium sulfide (CdS), tin oxide (SnO₂), or niobium oxide (Nb₂O₅).

In each of the above mentioned embodiments, the vapor concentration Cbp is detected by the vapor concentration sensors 44 and 45 serving as the concentration detection means. Instead, vapor pressure may be detected as a factor correlated with the vapor concentration Cbp by a pressure sensor corresponding to the concentration detection means. In this case, the vapor concentration (the vapor amount) can be estimated based on the detected vapor pressure.

While the presently preferred embodiment of the present invention has been shown and described, it is to be understood that this disclosure is for the purpose of illustration and that various changes and modifications may be made without departing from the scope of the invention as set forth in the appended claims.

1. An evaporated fuel collecting apparatus comprising:
a canister for collecting evaporated fuel generated in a fuel tank;
an adsorbent contained in the canister for adsorbing thereon the evaporated fuel;
the canister including an inflow port through which the evaporated fuel generated in the fuel tank is introduced into the canister, a purge port through which the collected evaporated fuel is purged from the canister, and an atmospheric port through which atmospheric air is introduced into the canister;
a photocatalyst which is provided in the canister in correspondence with the atmospheric port and oxidatively decomposes the evaporated fuel when exposed to light irradiation; and
light irradiation means for irradiating light to the photocatalyst.

2. The evaporated fuel collecting apparatus according to claim 1, further comprising
concentration detection means for detecting one of a concentration of the evaporated fuel and a factor correlated with the concentration, and
control means which controls the light irradiation means to emit light when the detected concentration or concentration-correlated-factor is a predetermined value or more.

3. The evaporated fuel collecting apparatus according to claim 2, wherein the control means calculates a target turn-on time according to a detected value of the evaporated fuel concentration or concentration-correlated-factor and controls the light irradiation means only for at least the calculated target turn-on time.

4. The evaporated fuel collecting apparatus according to claim 1, further comprising a porous plate provided in the canister in correspondence with the atmospheric port, wherein the porous plate having a three-dimensional skeleton structure, including pores that cross one another in every direction, and the porous plate is coated with the photocatalyst on a surface so that each pore remains open.

5. The evaporated fuel collecting apparatus according to claim 4, wherein
the light irradiation means includes a plurality of ultraviolet LEDs, which irradiate light to the surface of the porous plate coated with the photocatalyst.

6. The evaporated fuel collecting apparatus according to claim 5, wherein
the light emitted from each of the plurality of ultraviolet LEDs is irradiated in spot form to the surface of the porous plate coated with the photocatalyst so that spot light beams are arranged at equally angular intervals on a double circle to irradiate a whole area of the porous plate.

7. The evaporated fuel collecting apparatus according to claim 1, further comprising an adsorbent provided in the canister in correspondence with the atmospheric port, wherein the adsorbent is made of activated carbon including a large quantity of particles each surface of which is coated with the photocatalyst.

8. The evaporated fuel collecting apparatus according to claim 7, wherein
the light irradiation means includes a plurality of ultraviolet LEDs and a plurality of exposure-type optical fibers each extending from each ultraviolet LED, and each optical fiber is placed passing through the adsorbent made of activated carbon including a large quantity of particles each surface of which is coated with the photocatalyst, and the light emitted from each ultraviolet LED is allowed to leak from each optical fiber to its surroundings, thereby irradiating the adsorbent.

9. The evaporated fuel collecting apparatus according to claim 8, wherein
the plurality of optical fibers are disposed at equally angular intervals on a double circle in plan view.

10. The evaporated fuel collecting apparatus according to claim 8, wherein a surface of each optical fiber is coated with the photocatalyst.

11. The evaporated fuel collecting apparatus according to claim 1, wherein the photocatalyst includes one of titanium dioxide (TiO₂), cadmium selenide (CdSe), cadmium sulfide (CdS), tin oxide (SnO₂), and niobium oxide (Nb₂O₅), as a main ingredient.

12. An evaporated fuel collecting apparatus comprising:
a canister for collecting evaporated fuel generated in a fuel tank;
an adsorbent contained in the canister for adsorbing thereon the evaporated fuel;
the canister including an inflow port through which the evaporated fuel generated in the fuel tank is introduced into the canister, a purge port through which the collected evaporated fuel is purged from the canister, and an atmospheric port through which atmospheric air is introduced into the canister;
an atmospheric line communicating with the atmospheric port;
an air filter provided in the atmospheric line;
a photocatalyst which is provided in the air filter and oxidatively decomposes the evaporated fuel when exposed to light irradiation; and
light irradiation means for irradiating light to the photocatalyst.

13. The evaporated fuel collecting apparatus according to claim 12, further comprising
concentration detection means for detecting one of a concentration of the evaporated fuel and a factor correlated with the concentration, and
control means which controls the light irradiation means to emit light when the detected concentration or concentration-correlated-factor is a predetermined value or more.

14. The evaporated fuel collecting apparatus according to claim 13, wherein the control means calculates a target turn-on time according to a detected value of the evaporated fuel concentration or concentration-correlated-factor and controls the light irradiation means only for at least the calculated target turn-on time.

15. The evaporated fuel collecting apparatus according to claim 12, wherein the air filter is provided with a casing and a filter body which internally partitions the casing, the filter body includes right and left sides through which air is allowed to pass, and the photocatalyst is carried on a breathable sheet provided covering over a surface of each of the right and left sides of the filter body.

16. The evaporated fuel collecting apparatus according to claim 15, wherein the light irradiation means includes a plurality of ultraviolet LEDs, which are embedded at scattered places.

17. The evaporated fuel collecting apparatus according to claim 16, wherein a lens is disposed in a position in correspondence with each ultraviolet LED and a surface of each lens is coated with the photocatalyst.

18. The evaporated fuel collecting apparatus according to claim 12, wherein the air filter is provided with a casing and a filter which internally partitions the casing, the filter is formed of stainless wool which blocks high molecular components from passing therethrough, while allows low molecular components to pass therethrough, and the photocatalyst is carried on a surface of the filter.

19. The evaporated fuel collecting apparatus according to claim 18, wherein the light irradiation means is constructed of a plurality of ultraviolet LEDs provided in the casing, and light emitted from the plurality of ultraviolet LEDs is irradiated to the surface of the filter carrying the photocatalyst.

20. The evaporated fuel collecting apparatus according to claim 12, wherein the photocatalyst includes one of titanium dioxide (TiO₂), cadmium selenide (CdSe), cadmium sulfide (CdS), tin oxide (SnO₂), and niobium oxide (Nb₂O₅), as a main ingredient.
